(19) United States
(12) Patent Application Publication
(10) Pub. No.: US 2009/0011302 A1
(43) Pub. Date: Jan. 8, 2009

(54) Fuel Cell System

(75) Inventor: Kenichi Hamada, Hadano-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 12/087,456

(22) PCT Filed: Jul. 11, 2007
(86) PCT No.: PCT/JP2007/063800

§ 371 Date: Jul. 7, 2008

(30) Foreign Application Priority Data
Jul. 14, 2006 (JP) 2006-193723

(51) Int. Cl. H01M 8/04

(52) U.S. Cl. 429/25

(57) ABSTRACT

To provide a fuel cell system which controls pressure of reaction gas based upon a load reduction request of a fuel cell so that moisture inside the fuel cell can be efficiently discharged.

The fuel cell system comprises: a fuel cell which receives a supply of anode gas containing hydrogen at an anode and also receives a supply of cathode gas containing oxygen at a cathode, to generate power; a cathode off-gas flow path for flowing cathode off-gas exhausted from the cathode; a pressure regulator for regulating pressure of the cathode, which is arranged in the cathode off-gas flow path; and controlling means for controlling the pressure regulator such that the pressure of the cathode temporarily becomes lower than a prescribed target pressure value in the case of reducing the pressure of the cathode to the target pressure value based upon an output reduction request of the fuel cell. Preferably, pressure at an outlet of the cathode is reduced to the atmospheric pressure during a prescribed time period in a case where an output of the fuel cell changes from a prescribed high output value to a prescribed low output value during a prescribed time period.

### TECHNICAL FIELD

The present invention relates to a fuel cell system.

### BACKGROUND ART

A fuel cell has a stack structure formed by stacking a plurality of unit cells in each of which an anode and a cathode are arranged with an electrolyte membrane sandwiched therebetween. This structure has a mechanism where anode gas containing hydrogen comes into contact with the anode and cathode gas containing oxygen such as air comes into contact with the cathode, to bring about an electrochemical reaction at both electrodes so as to generate a voltage between both electrodes.

In such a fuel cell, the anode gas and the cathode gas in required amounts are supplied in accordance with a load request from the system. Conventionally, for example, Japanese Patent Laid-Open No. 2004-253208 discloses a system for controlling a flow rate and pressure of cathode gas that is supplied to a fuel cell. According to this system, the pressure of the cathode gas is controlled to be constantly appropriate pressure so as to reliably ensure a required flow rate of the cathode gas.

Patent Literature 1:
Japanese Patent Laid-Open No. 2004-253208

Patent Literature 2:
Japanese Patent Laid-Open No. Hei07-235324

Patent Literature 3:
Japanese Patent Laid-Open No. 2004-342473

Patent Literature 4:
Japanese Patent Laid-Open No. 2002-305017

Patent Literature 5:
Japanese Patent Laid-Open No. Hei08-45525

### DISCLOSURE OF INVENTION

### Problem to be Solved by the Invention

Incidentally, when the power generation reaction takes place in the fuel cell, hydrogen and oxygen in the reaction gas are reacted to generate water. Especially at the time of high load of the fuel cell when the power generation reaction vigorously takes place, such generated water is generated in a large amount. When a large amount of generated water stagnates inside the fuel cell, a flow path for the reaction gas might be blocked to cause deterioration in power generation efficiency. For this reason, a mechanism has been built where generated moisture is discharged to the outside of the fuel cell mainly along with cathode off-gas.

However, when the power generation reaction is abruptly prevented based upon an output reduction request from the system, the flow rate of the supplied reaction gas is reduced, thereby preventing the large amount of generated water generated at the time of high load from being efficiently discharged after the load has been shifted to low load. This could cause stagnation of the large amount of generated water inside the fuel cell, leading to deterioration in power generation efficiency.

The present invention was made for solving the problem as thus described, and has an object to provide a fuel cell system capable of efficiently discharging moisture inside a fuel cell by controlling pressure of reaction gas based upon a load reduction request of the fuel cell.

### Means for Solving the Problem

First aspect of the present invention is a fuel cell system, comprising:

a fuel cell which receives a supply of anode gas containing hydrogen at an anode and also receives a supply of cathode gas containing oxygen at a cathode, to generate power;

a cathode off-gas flow path for flowing cathode off-gas exhausted from said cathode;

a pressure regulator for regulating pressure of said cathode, which is arranged in said cathode off-gas flow path; and

controlling means for controlling said pressure regulator such that the pressure of said cathode temporarily becomes lower than a prescribed target pressure value in the case of reducing the pressure of said cathode to said target pressure value based upon an output reduction request of said fuel cell.

Second aspect of the present invention is the fuel cell system according to the first aspect, wherein said controlling means controls said pressure regulator such that the pressure of said cathode temporarily becomes lower than said target pressure value in a case where a requested output of said fuel cell changes from a prescribed high output value to a prescribed low output value during a prescribed time period.

Third aspect of the present invention is the fuel cell system according to the first aspect, wherein, in a vehicle mounted with said fuel cell, said controlling means controls said pressure regulator such that the pressure of said cathode temporarily becomes lower than said target pressure value in a case where an operating amount of an acceleration operating member of said vehicle changes from a prescribed high acceleration operating amount to a prescribed low acceleration operating amount during a prescribed time period.

Fourth aspect of the present invention is the fuel cell system according to any one of the first to the third aspects, wherein said pressure regulator is a pressure regulating valve, and

said controlling means makes an opening of said pressure regulating valve large during a prescribed period such that the pressure of said cathode temporarily becomes lower than said target pressure value.

Fifth aspect of the present invention is the fuel cell system according to the fourth aspect, wherein said controlling means fully opens said pressure regulating valve during a prescribed period.

Sixth aspect of the present invention is the fuel cell system according to any one of the first to the fifth aspects, further comprising inhibiting means for inhibiting execution of said controlling means during a prescribed period after execution of said controlling means.

Seventh aspect of the present invention is the fuel cell system according to any one of the first to the sixth aspects, further comprising:

impedance detecting means for detecting an impedance of said fuel cell; and

second inhibiting means for inhibiting execution of said controlling means in a case where said impedance is smaller than a prescribed value.

Eighth aspect of the present invention is the fuel cell system, comprising:

a fuel cell which receives a supply of anode gas containing hydrogen at an anode and also receives a supply of cathode gas containing oxygen at a cathode, to generate power;

flow rate controlling means for controlling an amount of cathode gas supplied to said cathode based upon an output request of said fuel cell;

a cathode off-gas flow path for flowing cathode off-gas exhausted from said cathode;

a valve arranged in said cathode off-gas flow path; and

controlling means for making an opening of said valve large during a prescribed period prior to reduction by said flow rate controlling means in amount of cathode gas supplied in the case of reducing the amount of cathode gas supplied based upon an output reduction request of said fuel cell.

Ninth aspect of the present invention is the fuel cell system according to the eighth aspect, wherein said flow rate controlling means includes a compressor arranged in a flow path for supplying said cathode gas, and controls said compressor based upon an output request of said fuel cell.

### Effects of the Invention

According to the first aspect of the present invention, pressure at an outlet of the cathode can be temporarily reduced when the output of the fuel cell shifts from high output to low output. Since the cathode pressure is reduced to prescribed target pressure when the output of the fuel cell is abruptly reduced, moisture generated at the time of high output tends to stagnate inside the fuel cell. Therefore, according to the present invention, the outlet pressure of the cathode is made lower than the target pressure in such a case, whereby it is possible to generate differential pressure between the internal pressure and the outlet pressure of the cathode, so as to efficiently discharge excess moisture inside the fuel cell to the outside.

According to the second aspect of the present invention, in a case where the output requested of the fuel cell changes from a prescribed high output value to low output value during a prescribed period, the outlet pressure of the cathode is reduced on the presumption that excess moisture stagnates inside the fuel cell. Therefore, according to the present invention, it is possible to accurately presume the stagnating state of the excess moisture inside the fuel cell based upon the change in output of the fuel cell, so as to perform the process for efficiently discharging such moisture.

According to the third aspect of the present invention, in the vehicle mounted with the fuel cell, in a case where the operating amount of the acceleration operating member of the vehicle changes from a prescribed high acceleration request to low acceleration request, the outlet pressure of the cathode is reduced on the presumption that excess moisture stagnates inside the fuel cell. Therefore, according to the present invention, it is possible to accurately presume the stagnating state of the excess moisture inside the fuel cell based upon the change in operating amount of the acceleration operating member of the vehicle, so as to perform the process for efficiently discharging such moisture.

According to the fourth aspect of the present invention, the pressure regulating valve is arranged in the cathode off-gas flow path for exhausting the cathode off-gas to the external space. Therefore, according to the present invention, it is possible to control the opening of the pressure regulating valve, so as to efficiently control the outlet pressure of the cathode.

According to the fifth aspect of the present invention, the pressure regulating valve is fully opened for reducing the outlet pressure. When the pressure regulating valve is opened, the cathode off-gas flow path is communicated with the external space. Therefore, according to the present invention, it is possible to efficiently reduce the outlet pressure of the cathode to the atmospheric pressure.

According to the sixth aspect of the present invention, in a case where the cathode pressure is controlled based upon an output reduction request of the fuel cell, re-execution of the control is inhibited during a prescribed time period after execution of the control. During a period when the cathode pressure is controlled, the cathode pressure value is temporarily off a normal control value. Therefore, according to the present invention, it is possible to prevent frequent control of the cathode pressure, so as to efficiently prevent hunting of the cathode pressure.

According to the seventh aspect of the present invention, in a case where the impedance of the fuel cell is detected and such an impedance value is smaller than a prescribed value, it can be determined that excess moisture to be discharged is not stagnating inside the fuel cell. Therefore, according to the present invention, since the state where the excess moisture is not stagnating is efficiently determined to inhibit control of the cathode pressure, it is possible to efficiently prevent unnecessary hunting of the cathode pressure.

Since the amount of cathode gas supplied is reduced when the output of the fuel cell shifts from high output to low output, moisture generated at the time of high output tends to stagnate inside the fuel cell. According to the eighth aspect of the present invention, prior to the process of reducing the amount of cathode gas supplied, the opening of the valve arranged in the cathode off-gas flow path is made large during a prescribed period. Therefore, according to the present invention, it is possible to reduce the outlet pressure of the cathode prior to reduction in cathode pressure, so as to efficiently discharge excess moisture inside the fuel cell to the outside.

According to the ninth aspect of the present invention, it is possible to control a flow rate of cathode gas to be supplied to the cathode by drive-controlling the compressor.

### BRIEF DESCRIPTION OF DRAWINGS

FIG. 1 is a view for explaining a configuration of a fuel cell system according to Embodiment 1 of the present invention.

FIG. 2 is the map to define the cathode pressure with respect to the FC output.

FIG. 3 is a timing chart showing a variety of states change of the fuel cell with respect to the load request of fuel cell.

FIG. 4 is a flowchart showing a routine to be executed in Embodiment 1 of the present invention.

FIG. 5 is a flowchart showing a routine to be executed in Embodiment 2 of the present invention.

FIG. 6 is a flowchart showing a routine to be executed in Embodiment 3 of the present invention.

### DESCRIPTION OF REFERENCE CHARACTERS

10 fuel cell stack

12 cathode gas flow path

14 cathode off-gas flow path

16 compressor

18 pressure regulating valve

20 pressure sensor

30 DC converter

32 load device

34 storage device

40 control section

### BEST MODE FOR CARRYING OUT THE INVENTION

In the following, one embodiment of the present invention is described with reference to drawings. It is to be noted that an element common in the drawings is provided with the equivalent numeral, and the repeated explanation thereof is omitted. Further, the following embodiments do not restrict the present invention.

### EMBODIMENT 1

### [Configuration of Embodiment 1]

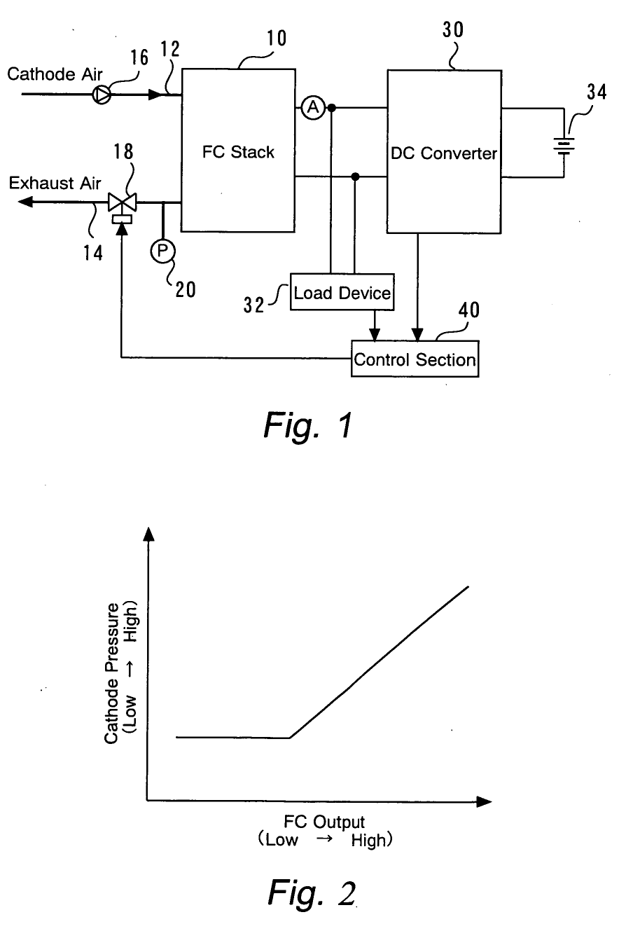

FIG. 1 is a view for explaining a configuration of a fuel cell system according to Embodiment 1 of the present invention. As shown in FIG. 1, the fuel cell system comprises a fuel cell stack 10. The fuel cell stack 10 is configured by stacking a plurality of fuel cells. Each of the fuel cells is configured such that an electrolyte membrane having proton conductivity, not shown, is sandwiched at both sides by an anode and a cathode, which is further sandwiched at both sides by conductive separators.

The fuel cell stack 10 is connected with a cathode gas flow path 12 for supplying cathode gas and a cathode off-gas flow path 14 for exhausting cathode off-gas. A compressor 16 is arranged in the cathode gas flow path 12. Air inhaled by activation of the compressor 16 is supplied to the fuel cell stack 10 through the cathode gas flow path 12. Further, a pressure regulating valve 18 is arranged in the cathode off-gas flow path 14. The pressure regulating valve 18 is capable of regulating the pressure of the cathode gas inside the fuel cell stack 10 to desired pressure. Further, a pressure sensor 20 is arranged on the upstream of the pressure regulating valve 18, which is capable of detecting the pressure of the cathode gas. The cathode gas having passed through the fuel cell stack 10 is exhausted as the cathode off-gas to the cathode off-gas flow path 14.

Further, the fuel cell stack 10 is connected with an anode gas flow path for supplying anode gas and an anode off-gas flow path, which are not shown. The upstream end of the anode gas flow path is connected to an anode gas supply source (high pressure hydrogen tank, reformer, etc.). The anode gas is supplied to the fuel cell stack 10 through the anode gas flow path, and then exhausted as anode off-gas to the anode off-gas flow path.

Moreover, the electrodes of the fuel cell stack 10 are connected to a DC converter 30 and a load device 32. The DC converter 30 is capable of controlling an output of the fuel cell stack 10 (hereinafter also referred to as “FC output”) by voltage control. Further, the DC converter 30 is provided with a storage device 34. The storage device 34 is comprised of a capacitor, a battery, and the like, and is capable of storing a current generated through a power generating reaction of the fuel cell stack 10.

Furthermore, the fuel cell system of the present embodiment comprises a control section 40. The control section 40 performs overall control of the DC converter 30 and of power generation of the fuel cell stack 10 based upon an output request of the load device 32.

### [Operation of Embodiment 1]

Next, an operation of the present embodiment is described with reference to FIG. 1. In the fuel cell system of the present embodiment, a requested-output signal of the load device 32 is supplied to the control section 40, as shown in FIG. 1. The requested-output is specified based upon an opening of an accelerator or the like, for example, in a vehicle mounted with the fuel cell system. The control section 40 performs power generation control of the fuel cell stack 10 based upon the requested-output signal.

When power generation is performed in the fuel cell stack 10, anode gas containing hydrogen is supplied to the anode of the fuel cell, and air containing oxygen is supplied to the cathode of the fuel cell. When hydrogen and oxygen are supplied to the fuel cell, electrochemical reactions (power generation reactions) expressed by the following formulas (1) and (2) occur in the vicinities of the anode and the cathode, respectively.

(anode): 2H₂→4H⁺+4e⁻ (1)

(cathode): O₂+4H⁺+4e⁻→2H₂O (2)

As expressed in the formula (1) above, hydrogen (H₂) supplied to the anode is separated into protons (H⁺) and electrons (e⁻) by catalysis of the anode. The protons move toward the cathode through the inside of the electrolyte membrane, and the electrons move toward the cathode through an external load such as the DC converter 30, the storage device 34, the load device 32, or the like. Subsequently, as expressed in the formula (2) above, oxygen (O₂) contained in the air that is supplied to the cathode, the electrons having passed through the load, and the protons having moved inside the electrolyte membrane generate water molecules (H₂O) by catalysis of the cathode. In the fuel cell stack 10, such a series of reactions are performed and air and hydrogen are successively supplied to generate power, and power is taken out at the load.

Further, the control section 40 controls amounts of the anode gas and the cathode gas supplied which are required for such power generation reaction. Here, the cathode gas in a desired flow rate is supplied to the fuel cell stack 10 by drive control of the compressor 16. Moreover, as for the pressure of the cathode gas, with power generation efficiency and the like taken into consideration, the optimum pressure of the cathode gas corresponding to the FC output has been defined by a map. FIG. 2 is one example of the map to define the cathode pressure with respect to the FC output. According to FIG. 2, the cathode pressure is controlled to a fixed low pressure value in a low FC output region, and the cathode pressure is controlled to increase with increase in FC output in other regions. The control section 40 drive-controls the compressor 16 and the pressure regulating valve 18 such that the pressure of the cathode gas detected by the pressure sensor 20 is a specified pressure value in accordance with the map.

The DC converter 30 performs control based upon a signal supplied from the control section 40 such that a current requested by the load device 32 is outputted to the load device 32. Here, the fuel cell stack 10 is unable to abruptly change output due to durability of the stack, a factor in terms of control, or the like. For this reason, the DC converter 30 is connected with the storage device 34. In the storage device 34, a current generated in the fuel cell stack 10 is stored. In the case of shortage of a current, such as when a high load request is abruptly made, the current stored in the storage device 34 is simultaneously used.

### [Characteristic Operation of Embodiment 1]

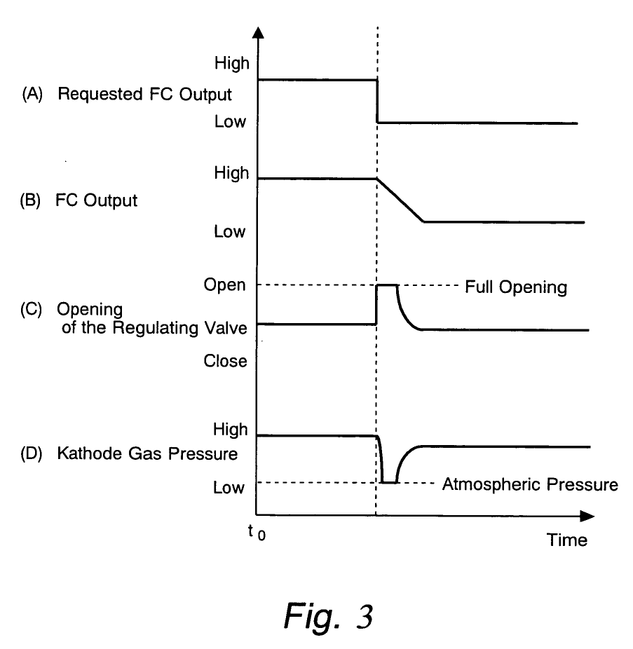

Next, a characteristic operation of the present embodiment is described with reference to FIG. 3. As described above, in the fuel cell system of the present embodiment, power generation control of the fuel cell stack 10 is performed based upon a load request from the load device 32. Here, when a high load request is given from the load device 32, since the power generation reaction expressed in the formula (2) above actively takes place in the fuel cell stack 10, a large amount of water is generated at the cathode. When this generated water stagnates in a large amount in the vicinity of the cathode inside the stack, it blocks the flow path for cathode gas, to cause deterioration in power generation efficiency. Therefore, the generated water is efficiently discharged to the outside of the fuel cell stack 10 along with the cathode off-gas that is exhausted.

FIG. 3 is a timing chart showing a variety of states of the fuel cell stack 10 in a case where the load request from the load device 32 abruptly varied from high load to low load. FIG. 3(A) shows a state where a requested FC output abruptly varied from a fixed high output value to a fixed low output value. FIG. 3(B) shows a variation in FC output with respect to the requested FC output shown in FIG. 3(A). As thus described, it is difficult in terms of the system to abruptly change the FC output. Therefore, as shown in FIG. 3(B), the FC output is controlled so as to shift from a high output operation to a low output operation through some transit period. It is to be noted that, as described above, during such a period, power stored in the storage device 34 is simultaneously used at the time of output shortage, or power is charged in the storage device 34 or stored like that at the time of power surplus, so as to deal with the load request.

Here, in the low power operation of the fuel cell stack 10, the power generation reaction is prevented, and the amount of cathode gas supplied is thereby reduced in accordance with the power generation amount. Therefore, during the transit time when the operation shifts from the high output operation to the low output operation, a large amount of moisture generated at the time of the high output operation might not be efficiently discharged to the outside. Such a state can occur, for example, when the operation shifts from a high output state at 60 KW or higher to a low output state at 20 KW or lower.

Here, in the present embodiment, the pressure of the cathode gas is changed during the transit operation of the fuel cell stack 10. FIGS. 3(C) and 3(D) are timing charts showing changes in opening of the pressure regulating valve 18 and in cathode gas pressure with respect to the change in requested FC output. As shown in FIG. 3(C), during the transit time from the high output operation to the low output operation, the pressure regulating valve 18 is temporarily controlled to full opening. FIG. 3(D) shows a condition where opening of the pressure regulating valve 18 temporarily brings the cathode off-gas flow path 14 into the state of being opened to the air, and pressure decreases to atmospheric pressure. Thereby, differential pressure occurs between the cathode pressure and the outlet pressure of the cathode inside the fuel cell system, and moisture stagnating in the vicinity of the cathode is discharged to the cathode off-gas flow path 14 along with the cathode off-gas. It is to be noted that the valve opening time is set within a range not hindering the subsequent power generation reaction (e.g. several hundreds of milliseconds).

As thus described, temporarily opening the pressure regulating valve 18 during the time of transit operation allows efficient discharge of generated water stagnating inside the fuel cell. It is thereby possible to prevent the generated water from blocking the cathode gas flow path, so as to efficiently enhance the power generation efficiency.

### [Specific Processing in Embodiment 1]

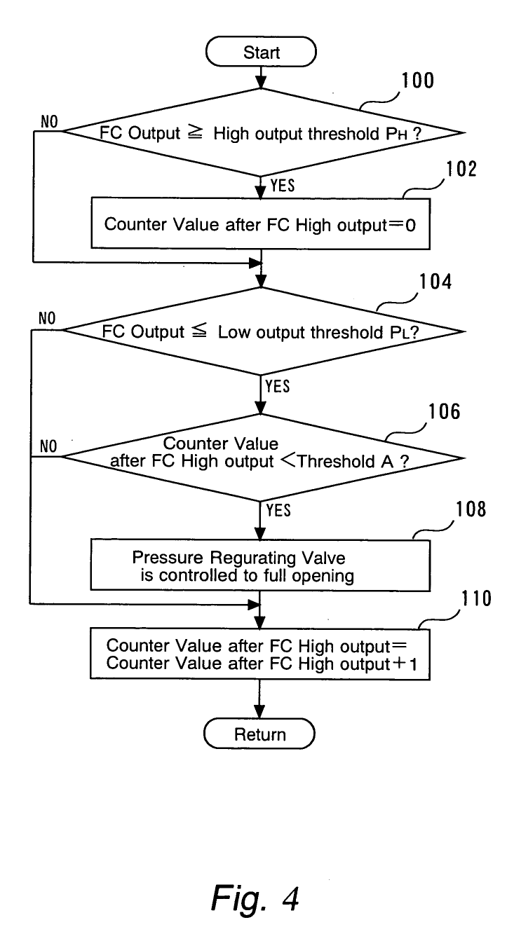

FIG. 4 is a flowchart showing a routine to be executed by the fuel cell system for discharging generated water stagnating at the cathode in Embodiment 1 of the present invention. The routine of FIG. 4 is one repeatedly executed during power generation of the fuel cell stack 10. In the routine shown in FIG. 4, first, it is determined whether or not the FC output is not lower than a prescribed high output threshold P_{H} (Step 100). Here, specifically, an FC output value is calculated based upon a detected current value of the fuel cell stack 10, and the FC output value and the high output threshold value P_{H} are compared in magnitude. The high output threshold P_{H} is set to an output value at which generated water is sufficiently generated through the power generation reaction (e.g. value of 60 to 90 KW).

In Step 100 above, when establishment of “FC output≧high output threshold P_{H}” is recognized, next, a counter value after FC high output is reset to zero (Step 102). Here, the counter value after FC high output is a counter value integrated in a later-described final step, Step 110, of the present routine, and a value with which the number of execution of the present routine after establishment of Step 100 above is determined. Therefore, it is possible to determine, from the counter value and a period for executing the present cycle, the time required for reducing the FC output after the FC output has reached the high output threshold P_{H}.

After Step 102 above, or when establishment of “FC output≧high output threshold P_{H}” is not recognized in Step 100 above, it is determined next whether or not the FC output is not higher than a prescribed low output threshold P_{L} (Step 104). The low output threshold P_{L} is set to an output value at which water generated through the power generation reaction cannot be sufficiently discharged (e.g. value of 0 to 20 KW).

In Step 104 above, when establishment of “FC output≦low output threshold P_{L}” is recognized, next, it is determined whether or not the counter value after FC high output is smaller than a threshold A (Step 106). As described above, only when the cathode gas flow rate is abruptly reduced due to an abrupt decrease in FC output, the stack comes into a state where water generated through the power generation reaction cannot be sufficiently discharged. Therefore, by comparing the counter value after FC high output with the threshold A, it is possible to determine whether or not the generated water to be discharged is stagnating inside the fuel cell stack 10 in a case where the FC output value changes from a value not lower than the high output threshold P_{H} to a value not higher than the low output threshold _{P}L. It is to be noted that the threshold A is specified by the relation between the high output threshold P_{H} and the low output threshold P_{L}.

In Step 106 above, when establishment of “counter value after FC high output<threshold A” is recognized, next, the pressure regulating valve 18 of the cathode gas is subjected to valve opening control (Step 108). Here, specifically, the pressure regulating valve 18 is controlled to full opening, and the cathode off-gas flow path 14 is opened to the air. The valve opening time is set to relatively short time (e.g. a prescribed value not longer than 1 second) so as not to hinder the subsequent power generation reaction. With this valve opening control, the outlet pressure of the cathode temporarily becomes extremely lower than pressure in the vicinity of the cathode inside the fuel cell stack 10, and it is thereby possible to discharge the generated water in a large amount along with the cathode off-gas inside the fuel cell stack 10. It is to be noted that, after the open valve control for the prescribed time period, the pressure of the cathode gas is controlled to a cathode gas pressure value in accordance with the FC output.

After the process of Step 108 above, or when establishment of the condition is not recognized in Step 104 or 106 above, the foregoing counter value after FC high output is integrated (Step 110), and the present routine is finished.

As described above, according to the routine shown in FIG. 4, when the FC output changes from the prescribed high output threshold P_{H} to the prescribed low output threshold P_{L} within a prescribed time period, the pressure regulating valve 18 is subjected to the valve opening control, and the cathode off-gas flow path 14 is opened to the air. It is thereby possible to efficiently discharge the generated water stagnating inside the fuel cell stack 10, so as to prevent occurrence of flooding.

Incidentally, although in Embodiment 1 described above, the pressure regulating valve 18 is controlled to full opening during the transit time of the FC output, to reduce the pressure of the cathode gas to the atmospheric pressure so as to efficiently discharge the generated water inside the fuel cell stack 10, the method for controlling the cathode gas pressure is not restricted to this. Namely, the pressure regulating valve 18 is not necessarily controlled to full opening so long as the outlet pressure of the cathode is temporarily made lower than a prescribed control value (target pressure value) to allow efficient discharge of the generated water. Further, another pressure regulator may be used in place of the pressure regulating valve 18.

Moreover, although in Embodiment 1 described above, it is determined that the generated water has come into the state of stagnating in a large amount in the vicinity of the cathode of the fuel cell stack 10 when the FC output calculated based upon a current value of the fuel cell stack 10 changes from a prescribed high output value to a prescribed low output value within a prescribed time period, determination of such a state is not restricted to this. Namely, for example, in a vehicle mounted with the fuel cell system, a change in FC output may be estimated from a detected change in accelerator (accelerating operation member) operating amount (e.g. when the accelerator opening is decreased from 80 to 50% within a prescribed time period), to determine the stagnating state of the generated water in the vicinity of the cathode.

Furthermore, in Embodiment 1 described above, although the pressure regulating valve 18 is temporarily controlled to full opening during the transit operation time when the FC output shifts from prescribed high output to prescribed low output, namely, during a period when control for reducing the cathode pressure is executed, the timing for executing the control for reducing the cathode pressure as well as the control for opening the pressure regulating valve 18 is not restricted to this. Namely, when the opening of the pressure regulating valve 18 is made large prior to execution of the control for reducing the cathode pressure, differential pressure between the cathode pressure and the outlet pressure of the cathode can be made large.

More specifically, the control for reducing the cathode pressure is performed by lowering the number of rotation of the compressor 16 to reduce the amount of cathode gas supplied, and also controlling the opening of the pressure regulating valve 18 to regulate the pressure to desired one. Therefore, temporarily increasing the opening of the pressure regulating valve prior to the control for reducing the amount of cathode gas supplied by the compressor 16 to reduce resistance of the flow path enables efficient improvement in water discharge property. It is to be noted that as the modified example, the control may be executed in combination with the control of the cathode pressure in Embodiment 1 described above, or only the control of the amount of cathode gas supplied may be independently executed. In either case, it is possible to increase differential pressure between the cathode pressure and the cathode outlet pressure, so as to efficiently improve the water discharge property.

Further, although in the foregoing modified example, the amount of cathode gas supplied is controlled by drive-controlling the compressor 16, the configuration to control the amount of cathode gas supplied is not particularly restricted to this, and another known system may be utilized. Moreover, as for the pressure regulating valve 18, a variety of valves such as an opening/closing valve not having a regulating function are usable so long as being capable of decreasing the cathode outlet pressure.

It is to be noted that in Embodiment 1 described above, the pressure regulating valve 18 corresponds to the “pressure regulator” in the first invention, and the control section 40 executes the process of Step 108 above, to realize the “control means” in the first to third and fifth inventions.

Further, in Embodiment 1 described above, the pressure regulating valve 18 corresponds to the “valve” in the eighth invention, and the control section 40 executes the process of Step 108 above, to realize the “control means” in the eighth invention.

### EMBODIMENT 2

### [Characteristic of Embodiment 2]

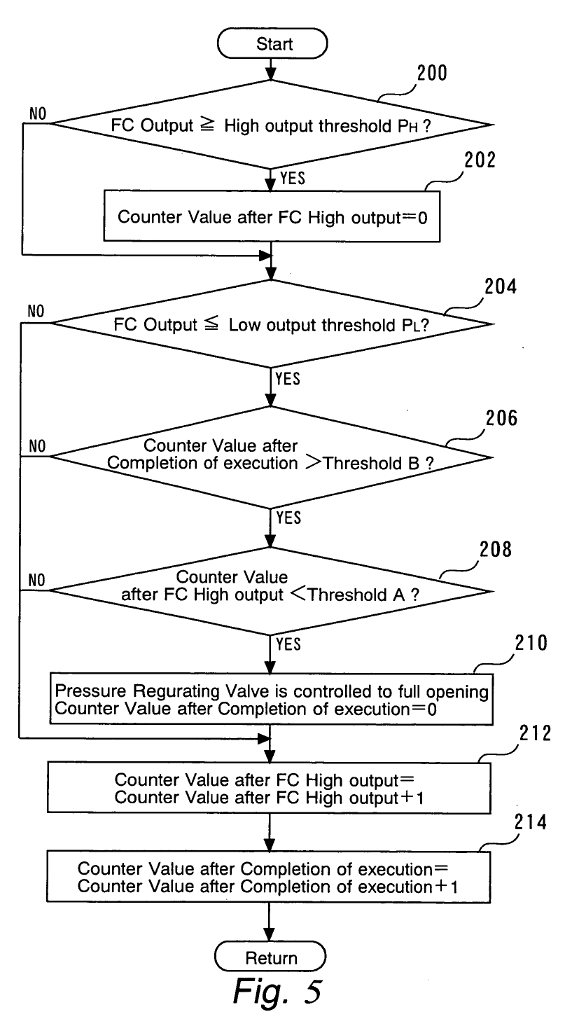

Embodiment 2 can be realized by allowing the control section 40 to execute a later-described routine shown in FIG. 5, by using the hardware configuration shown in FIG. 1.

In Embodiment 1 described above, the state of the generated water stagnating in the vicinity of the cathode of the fuel cell stack 10 is estimated based upon the change in FC output. Then, the pressure regulating valve 18 is drive-controlled, to control the outlet pressure of the cathode so that the generated water stagnating inside the stack can be efficiently discharged.

Incidentally, in the control of Embodiment 1 above, the pressure regulating valve 18 is controlled to full opening, and the pressure of the cathode temporarily decreases to the atmospheric pressure. Upon completion of the process for discharging the generated water, the pressure regulating valve 18 is again driven-controlled, and the pressure is controlled to a regular pressure. Therefore, when such control is frequently performed, the pressure of the cathode becomes unstable and generates hunting, which may cause deterioration in power generation efficiency.

Accordingly, in Embodiment 2, re-execution of the generated water discharge control is inhibited during a specific time period after execution of such control. It is thereby possible to efficiently prevent deterioration in power generation efficiency due to hunting of the cathode pressure.

### [Specific Processing in Embodiment 2]

FIG. 5 is a flowchart showing a routine to be executed by the fuel cell system for discharging generated water stagnating at the cathode in Embodiment 2 of the present invention. The routine of FIG. 5 is one repeatedly executed during power generation of the fuel cell stack 10. In the routine shown in FIG. 5, first, it is determined whether or not the FC output is not lower than the prescribed high output threshold P_{H} (Step 200). When establishment of “FC output≧high output threshold P_{H}” is recognized, next, the counter value after FC high output is reset to zero (Step 202). Here, specifically, the same processes as in Steps 100 and 102 of the routine shown in FIG. 4 are executed.

After Step 202 above or when establishment of “FC output≧high output threshold P_{H}” is not recognized in Step 200 above, it is determined next whether or not the FC output is not higher than the prescribed low output threshold P_{L} (Step 204). Here, specifically, the same process as in Step 104 of the routine shown in FIG. 4 is executed.

In Step 204 above, when establishment of “FC output≦low output threshold P_{L}” is recognized, next, it is determined whether or not a counter value after completion of execution is larger than a prescribed threshold B (Step 206). Here, the counter value after completion of execution is a counter value integrated in a later described final step, Step 214, of the present routine, and a value with which the number of execution of the present routine after execution of control of the pressure regulating valve 18 in later-described Step 210 is determined. Therefore, it is possible to determine, from the counter value and a period for executing the present cycle, the time elapsed after the fuel cell system has executed the control of the pressure regulating valve 18 to full opening.

In Step 206 above, when establishment of “counter value after completion of execution>threshold B” is recognized, it can be determined that prescribed time has been elapsed since previous execution of the control of the pressure regulating valve to full opening. Therefore, the process is shifted to a subsequent step, and it is determined whether or not the counter value after FC high output is smaller than the prescribed threshold A (Step 208). Here, specifically, the same process as in Step 106 of the routine shown in FIG. 4 is executed.

In Step 208 above, when establishment of “counter value after PC high output<threshold A” is established, next, the pressure regulating valve of the cathode gas is controlled to full opening (Step 210). Here, specifically, the same process as in Step 106 of the routine shown in FIG. 4 is executed, and a process of resetting the counter value after completion of execution to zero is also executed.

After the process of Step 210 above, or when establishment of the condition is not recognized in Step 204, 206 or 208 above, the process of integrating the foregoing counter value after FC high output (Step 212) and the process of integrating the foregoing counter value after completion of execution (Step 214) are executed, and the present routine is finished.

As described above, according to the routine shown in FIG. 5, in a case where the FC output changes from the prescribed high output threshold P_{H} to the prescribed low output threshold P_{L} within a prescribed time period and the pressure regulating valve 18 is subjected to the valve opening control, subsequent valve opening control of the pressure regulating valve 18 is inhibited. It is thereby possible to prevent hunting of the cathode pressure due to frequent performance of the valve opening control of the pressure regulating valve, so as to prevent deterioration in power generation efficiency of the fuel cell stack 10.

Incidentally, although in Embodiment 2 described above, the pressure regulating valve 18 is controlled to full opening during the transit time of the FC output, to reduce the pressure of the cathode gas to the atmospheric pressure so as to efficiently discharge the generated water inside the fuel cell stack 10, the method for controlling the cathode gas pressure is not restricted to this. Namely, the pressure regulating valve 18 is not necessarily controlled to full opening so long as the outlet pressure of the cathode is temporarily made lower than a prescribed control value to allow efficient discharge of the generated water. Further, another pressure regulator may be used in place of the pressure regulating valve 18.

Moreover, although in Embodiment 2 described above, it is determined that the generated water has come into the state of stagnating in a large amount in the vicinity of the cathode of the fuel cell stack 10 when the FC output calculated based upon a current value of the fuel cell stack 10 changes from a prescribed high output value to a prescribed low output value within a prescribed time period, determination of such a state is not restricted to this. Namely, for example, in a vehicle mounted with the fuel cell system, a change in FC output may be estimated from a detected change in accelerator operating amount (e.g. when the accelerator opening is decreased from 80 to 50% within a prescribed time period), to determine the stagnating state of the generated water in the vicinity of the cathode.

It is to be noted that in Embodiment 2 described above, the pressure regulating valve 18 corresponds to the “pressure regulator” in the first invention, and the control section 40 executes the process of Step 210 above, to realize the “control means” in the first to third and fifth inventions.

Further, in Embodiment 2 described above, the control section 40 executes the process of Step 208 above, to realize the “inhibiting means” in the sixth invention.

### EMBODIMENT 3

### [Characteristic of Embodiment 3]

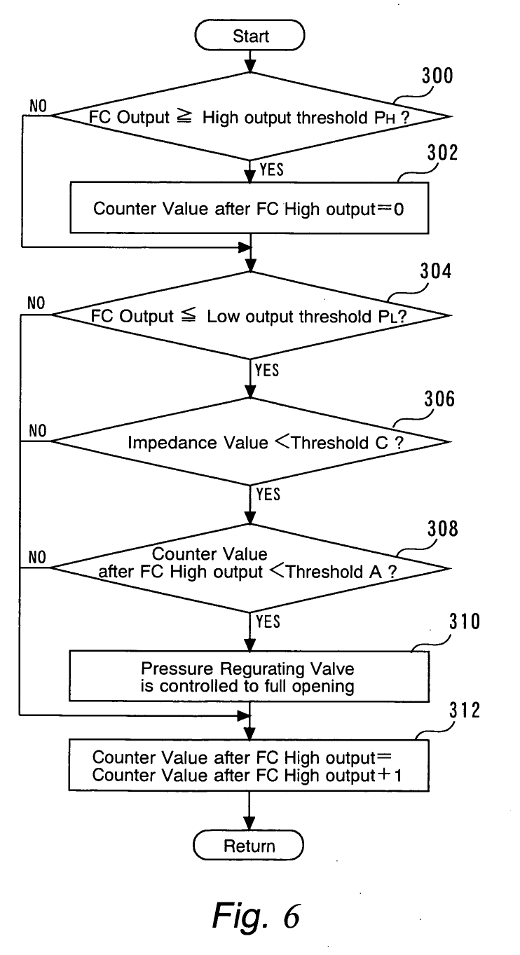

Embodiment 3 can be realized by allowing the control section 40 to execute a later-described routine shown in FIG. 6, by using the hardware configuration shown in FIG. 1.

In Embodiment 1 described above, the state of the generated water stagnating in the vicinity of the cathode of the fuel cell stack 10 is estimated based upon the change in FC output. Then, the pressure regulating valve 18 is drive-controlled, to control the outlet pressure of the cathode so that the generated water stagnating inside the stack can be efficiently discharged.

Incidentally, a wet state of the electrolyte membrane of the fuel cell stack 10 can also be determined by detecting an impedance of the fuel cell stack 10. More specifically, it can be determined that the larger the impedance value, the drier is the state of the electrolyte membrane of the fuel cell stack 10.

Therefore, in Embodiment 3 of the present invention, in addition to the condition of Embodiment 1 described above, the wet state of the electrolyte membrane is determined from the impedance of the fuel cell stack 10, and when the electrolyte membrane can be determined to be dry, execution of the valve opening control of the pressure regulating valve 18 is inhibited. It is thereby possible to efficiently prevent execution of discharge control of the generated water despite the non-existence of the generated water to be discharged.

### [Specific Processing in Embodiment 3]

FIG. 6 is a flowchart showing a routine to be executed by the fuel cell system for discharging generated water stagnating at the cathode in Embodiment 3 of the present invention. The routine of FIG. 6 is one repeatedly executed during power generation of the fuel cell stack 10. In the routine shown in FIG. 6, first, it is determined whether or not the FC output is not lower than the prescribed high output threshold P_{H} (Step 300). When establishment of “FC output≧high output threshold P_{H}” is recognized, next, the counter value after FC high output is reset to zero (Step 302). Here, specifically, the same processes as in Steps 100 and 102 of the routine shown in FIG. 4 are executed.

After Step 302 above, or when establishment of “FC output≧high output threshold P_{H}” is not recognized in Step 300 above, it is determined next whether or not the FC output is not higher than the low output threshold P_{L} (Step 304). Here, specifically, the same process as in Step 104 of the routine shown in FIG. 4 is executed.

In Step 304 above, when establishment of “FC output≦low output threshold P_{L}” is recognized, next, it is determined whether or not the impedance of the fuel cell stack 10 is smaller than a prescribed threshold C (Step 306). Here, specifically, first, the impedance value of the fuel cell system is detected. Subsequently, it is determined whether or not such an impedance value is smaller than the prescribed threshold C. It is to be noted that the threshold C is set based upon whether or not the wet state of the fuel cell stack 10 has reached the extent that the generated water should be discharged.

In Step 306 above, when establishment of “impedance value<threshold C” is recognized, it can be determined that the generated water to be discharged is stagnating inside the fuel cell stack 10. Therefore, the process is shifted to a subsequent step, and it is determined whether or not the counter value after FC high output is smaller than the prescribed threshold A (Step 308). Here, specifically, the same process as in Step 106 of the routine shown in FIG. 4 is executed.

In Step 308 above, when establishment of “counter value after PC high output<threshold A” is recognized, next, the pressure regulating valve of cathode gas is subjected to the valve opening control (Step 310). Here, specifically, the same process as in Step 106 of the routine shown in FIG. 4 is executed.

After the process of Step 310 above, or when establishment of the condition is not recognized in Step 304, 306 or 308 above, the process of integrating the foregoing counter value after FC high output (Step 312) and the process of integrating the foregoing counter value after completion of execution (Step 314) are executed, and the present routine is finished.

As described above, according to the routine shown in FIG. 6, in a case where it is determined from the impedance value of the fuel cell stack 10 that the generated water to be discharged outside does not exist, the valve opening control of the pressure regulating valve 18 is inhibited. It is thereby possible to prevent unnecessary valve opening control of the pressure regulating valve, so as to prevent deterioration in power generation efficiency of the fuel cell stack 10 due to hunting of the cathode pressure.

Incidentally, although in Embodiment 3 described above, the pressure regulating valve 18 is controlled to full opening during the transit time of the FC output, to reduce the pressure of the cathode gas to the atmospheric pressure so as to efficiently discharge the generated water inside the fuel cell stack 10, the method for controlling the cathode gas pressure is not restricted to this. Namely, the pressure regulating valve 18 is not necessarily controlled to full opening so long as the outlet pressure of the cathode is temporarily made lower than a prescribed control value to allow efficient discharge of the generated water. Further, another pressure regulator may be used in place of the pressure regulating valve 18.

Moreover, although in Embodiment 3 described above, it is determined that the generated water has come into the state of stagnating in a large amount in the vicinity of the cathode of the fuel cell stack 10 when the FC output calculated based upon a current value of the fuel cell stack 10 changes from a prescribed high output value to a prescribed low output value within a prescribed time period, determination of such a state is not restricted to this. Namely, for example, in a vehicle mounted with the fuel cell system, a change in FC output may be estimated from a detected change in accelerator operating amount (e.g. when the accelerator opening is decreased from 80 to 50% within a prescribed time period), to determine the stagnating state of the generated water in the vicinity of the cathode.

Furthermore, although in Embodiment 3 described above, whether or not the generated water to be discharged is stagnating inside the fuel cell stack 10 is determined, as a condition of whether or not to control the cathode pressure, from both the impedance value of the fuel cell stack 10 and the change in FC output value shown in Embodiment 1, the condition of executing the control is not restricted to this. Namely, the control of discharge of the generated water may be executed by determining the state of the generated water only from the impedance value of the fuel cell stack 10, or it may also be executed in combination with the control shown in Embodiment 2.

Moreover, although in Embodiment 3 described above, the threshold A is specified as a threshold of the time required for a change in FC output from the high output threshold P_{H} to the low output threshold P_{L} from the relation between P_{H} and P_{L} when such a change is made to cause stagnation of the generated water to be discharged inside the fuel cell stack 10, the method for specifying the threshold A is not restricted to this. Namely, the threshold A may be specified from the relation with the impedance value of the fuel cell stack 10.

It is to be noted that in Embodiment 3 described above, the pressure regulating valve 18 corresponds to the “pressure regulator” in the first invention, and the control section 40 executes the process of Step 310 above, to realize the “control means” in the first to third and fifth inventions.

Further, in Embodiment 3 described above, the control section 40 executes the process of Step 306 above, to realize the “second inhibiting means” in the seventh invention.

1. A fuel cell system, comprising:
a fuel cell which receives a supply of anode gas containing hydrogen at an anode and also receives a supply of cathode gas containing oxygen at a cathode, to generate power;
a cathode off-gas flow path for flowing cathode off-gas exhausted from said cathode;
a pressure regulator for regulating pressure of said cathode, which is arranged in said cathode off-gas flow path; and
controlling means for controlling said pressure regulator such that the pressure of said cathode temporarily becomes lower than a prescribed target pressure value in the case of reducing the pressure of said cathode to said target pressure value based upon an output reduction request of said fuel cell.

2. The fuel cell system according to claim 1, wherein said controlling means controls said pressure regulator such that the pressure of said cathode temporarily becomes lower than said target pressure value in a case where a requested output of said fuel cell changes from a prescribed high output value to a prescribed low output value during a prescribed time period.

3. The fuel cell system according to claim 1,
wherein, in a vehicle mounted with said fuel cell, said controlling means controls said pressure regulator such that the pressure of said cathode temporarily becomes lower than said target pressure value in a case where an operating amount of an acceleration operating member of said vehicle changes from a prescribed high acceleration operating amount to a prescribed low acceleration operating amount during a prescribed time period.

4. The fuel cell system according to claim 1, wherein said pressure regulator is a pressure regulating valve, and
said controlling means makes an opening of said pressure regulating valve large during a prescribed period such that the pressure of said cathode temporarily becomes lower than said target pressure value.

5. The fuel cell system according to claim 4, wherein said controlling means fully opens said pressure regulating valve during a prescribed period.

6. The fuel cell system according to claim 1, further comprising inhibiting means for inhibiting execution of said controlling means during a prescribed period after execution of said controlling means.

7. The fuel cell system according to claim 1, further comprising:
impedance detecting means for detecting an impedance of said fuel cell; and
second inhibiting means for inhibiting execution of said controlling means in a case where said impedance is smaller than a prescribed value.

8. A fuel cell system, comprising:
a fuel cell which receives a supply of anode gas containing hydrogen at an anode and also receives a supply of cathode gas containing oxygen at a cathode, to generate power;
flow rate controlling means for controlling an amount of cathode gas supplied to said cathode based upon an output request of said fuel cell;
a cathode off-gas flow path for flowing cathode off-gas exhausted from said cathode;
a valve arranged in said cathode off-gas flow path; and
controlling means for making an opening of said valve large during a prescribed period prior to reduction by said flow rate controlling means in amount of cathode gas supplied in the case of reducing the amount of cathode gas supplied based upon an output reduction request of said fuel cell.

9. The fuel cell system according to claim 8, wherein said flow rate controlling means includes a compressor arranged in a flow path for supplying said cathode gas, and controls said compressor based upon an output request of said fuel cell.

10. A fuel cell system, comprising:
a fuel cell which receives a supply of anode gas containing hydrogen at an anode and also receives a supply of cathode gas containing oxygen at a cathode, to generate power;
a cathode off-gas flow path for flowing cathode off-gas exhausted from said cathode;
a pressure regulator for regulating pressure of said cathode, which is arranged in said cathode off-gas flow path; and
a controlling device for controlling said pressure regulator such that the pressure of said cathode temporarily becomes lower than a prescribed target pressure value in the case of reducing the pressure of said cathode to said target pressure value based upon an output reduction request of said fuel cell.
